(19) United States
(12) Patent Application Publication
(10) Pub. No.: US 2007/0040298 A1
(43) Pub. Date: Feb. 22, 2007

(54) Assembly and a method for cooling and/or forming an item

(76) Inventor: Mark Manuel, Shelby Township, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/206,934

(22) Filed: Aug. 18, 2005

(51) Int. Cl. B29C 71/00

(52) U.S. Cl. 264/237

(57) ABSTRACT

An assembly 10 which may selectively form and/or cool an item, such as an automotive fuel tank 300. Such cooling is accomplished in a highly efficient manner.

### GENERAL BACKGROUND

1. Field of the Invention

The present invention generally relates to an assembly and to a method for cooling and/or forming an item and more particularly to an assembly which allows an item to be efficiently cooled and/or formed and to a highly efficient cooling and forming methodology.

2. Background of the Invention

An item, such as an automotive fuel tank, is often formed within a tool. Particularly, the formed item must typically be taken from the tool and cooled in order to complete the formation process. Such a separate cooling operation undesirably increases the item formation process time (e.g., making the overall process inefficient) and increases the likelihood of damage to the item taken from the tool (e.g., the “preformed part” or “prepart”).

Moreover, these tools are conventionally formed or created from a “block of material” which is machined or “worked” in a certain manner in order to form the desired tooling surface used to form the desired item. This tool construction is costly and is complicated, thereby undesirably increasing the likelihood that the created tool will be errantly made, and increasing the likelihood of damage to the partially formed tool.

There is therefore a need for an assembly which allows a pre-formed item to be efficiently cooled and for a tooling assembly which allows an item to be efficiently formed and subsequently cooled in a new and novel manner, thereby addressing the various drawbacks and disadvantages of prior techniques and strategies which have been delineated above. The present invention addresses these drawbacks and disadvantages in a new and novel manner.

### SUMMARY OF THE INVENTION

It is a first non-limiting object of the present invention to provide an assembly and a method which overcome the various disadvantages of prior techniques and strategies.

It is a second non-limiting object of the present invention to provide an assembly and a method which overcome the various disadvantages of prior techniques and strategies, including those which have been delineated above and which allow an item to be efficiently cooled.

It is third non-limiting object of the present invention to provide an assembly and a method which overcomes the various disadvantages of prior techniques and strategies, including those which have been delineated above and which allow an item to be efficiently cooled.

According to a first non-limiting aspect of the present invention, an assembly is provided and includes a plurality of spaced apart plates which are fixed within a carrier and which cooperatively define the shape of a certain item.

According to a second non-limiting aspect of the present invention an assembly is provided which includes a first carrier portion having a floor which includes a first strip of protruding teeth, a first wall which includes a second strip of protruding teeth, and a second wall which includes a third strip of protruding teeth and wherein the first and second walls cooperate with the floor to form a containment portion and wherein the second and third strips of protruding teeth extend in opposite directions and into the containment portion and are linearly coextensive, and a plurality of plates which are fixedly secured within the containment area, wherein each of the plurality of plates is respectively disposed between two unique teeth of the first strip of protruding teeth, between two unique teeth of the second strip of protruding teeth, and between two unique teeth of the third strip of protruding teeth; and a second top portion which is adapted to selectively engage the carrier portion.

According to a third non-limiting aspect of the present invention, an assembly for forming and cooling a part is provided and includes a substantially rectangular carrier having a floor and two pairs of opposed walls which cooperate with the floor to form a containment cavity, wherein the assembly includes a first strip of teeth which is disposed above the floor and along the entire length of a first of said walls; a second strip of teeth which is disposed along the entire length of a second of the walls and wherein the second strip of teeth is linearly coextensive to the first strip of teeth; and a third strip of teeth which is disposed upon the floor and which is linearly coextensive to the first and second strips of teeth and wherein the first strip of teeth extend into the containment cavity in a first direction and wherein the second strip of teeth extend into the containment cavity in a second direction which is opposite to the first direction; and wherein the assembly further includes a first plurality of plates which are respectively disposed between unique pairs of teeth on the first strip of teeth and between unique pairs of teeth on the second strip of teeth, and between unique pairs of teeth on the third strip of teeth.

According to a fourth non-limiting aspect of the present invention, a method of cooling an item is provided and includes the steps of creating an assembly containing spaced apart plates; and placing the item upon the spaced apart plates; and placing a cooling media in contact with the assembly.

According to a fifth non-limiting aspect of the present invention, a method of forming and cooling an item is provided and includes the steps of forming an assembly which includes a carrier having a plurality of spaced apart plates; forming the item within the carrier by use of the plurality of spaced apart plates; and cooling the formed item.

These and other features, aspects, and advantages of the present invention will become apparent from a reading of the following detailed description of the preferred embodiment of the invention, including the subjoined claims, and by reference to the following drawings.

### BRIEF DESCRIPTION OF THE DRAWINGS

FIG. 1 is a perspective view of the assembly made in accordance with the teaching of the preferred embodiment of the invention;

FIG. 2 is a top view of a portion of the assembly which is shown in FIG. 1;

FIG. 3 is an exploded view of the assembly which is shown in FIGS. 1 and 2;

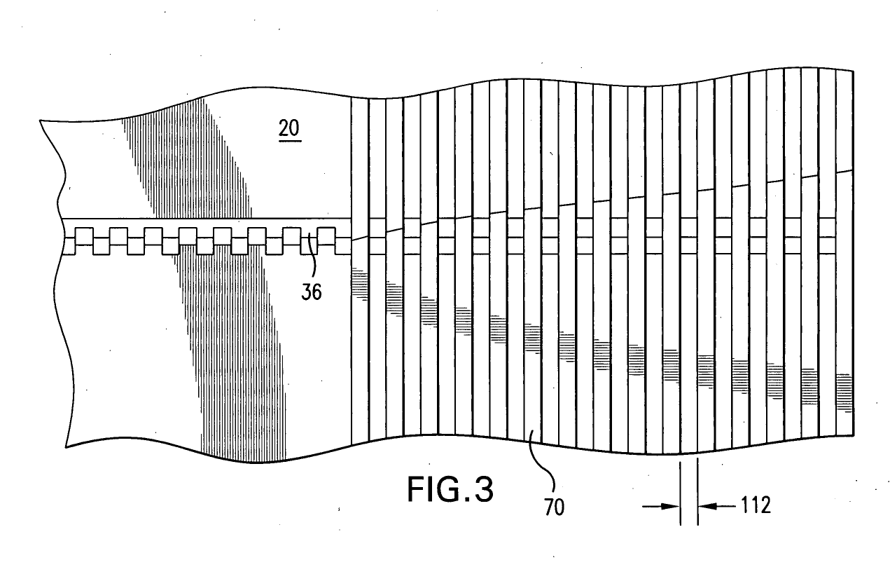

FIG. 4 is an exploded view of a second portion of the assembly which is shown in FIGS. 1 and 2;

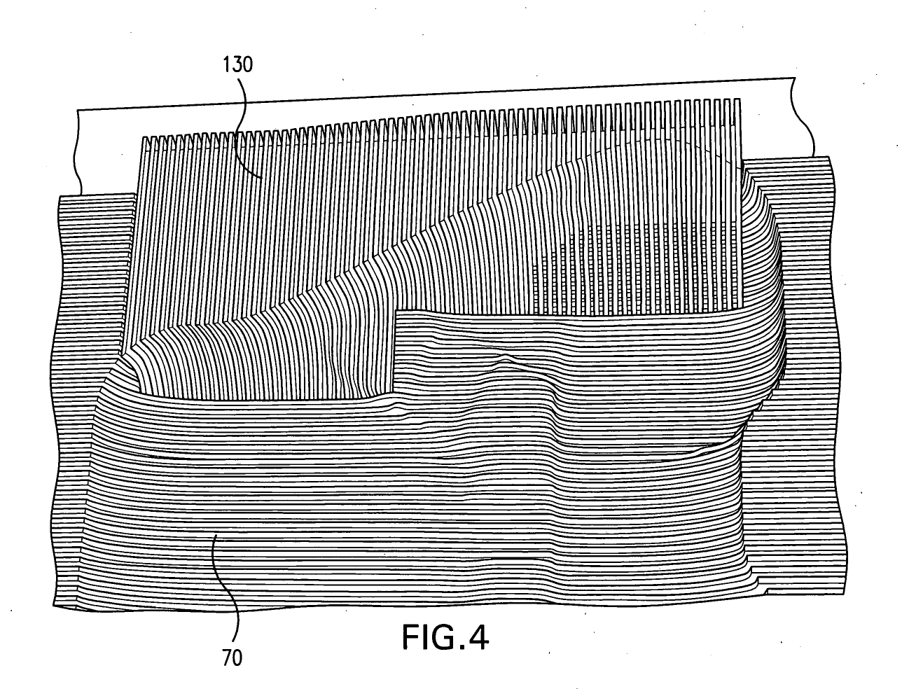

FIG. 5 is an exploded view of a third portion of the assembly which is shown in FIGS. 1 and 2; and

FIG. 6 is a side view of the assembly which is shown in FIG. 1 and which contains and is cooling the preformed object.

### DETAILED DESCRIPTION OF THE PREFERRED EMBODIMENT OF THE INVENTION

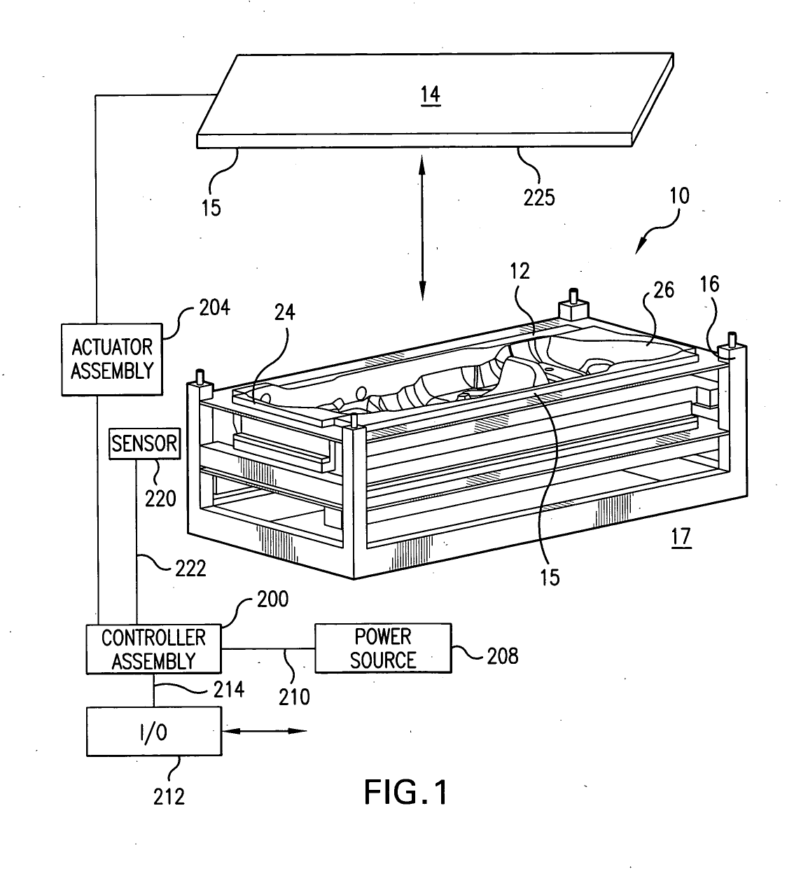

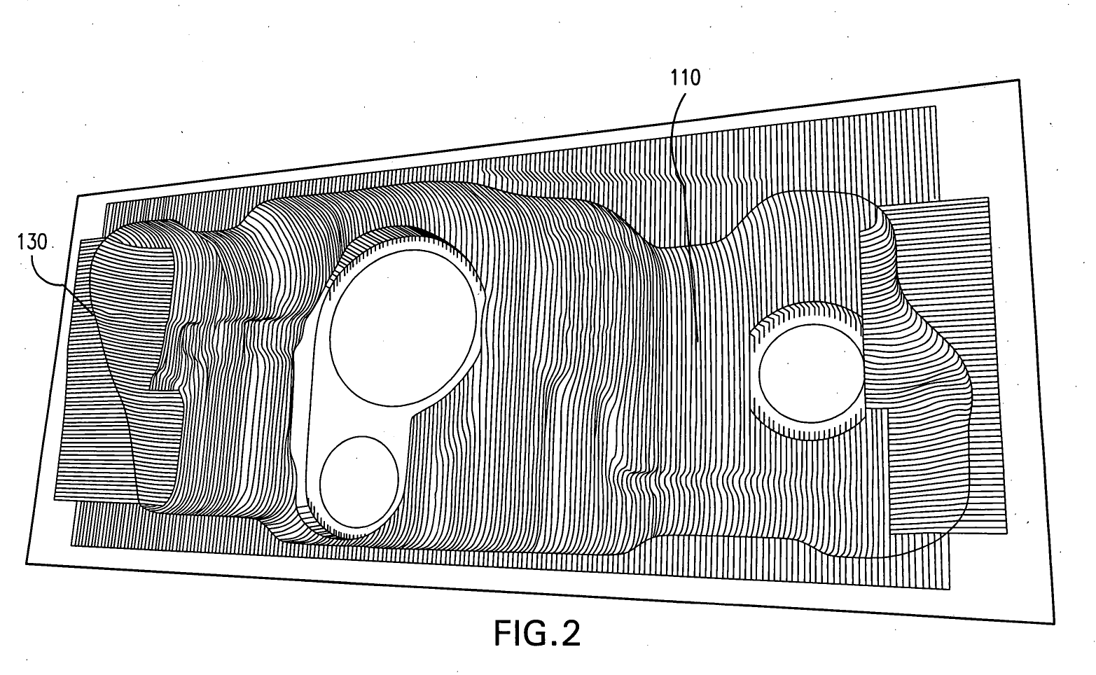

Referring now to FIGS. 1 and 2, there is shown an item forming and cooling assembly 10 which is made in accordance with the teachings of the preferred embodiment of the invention.

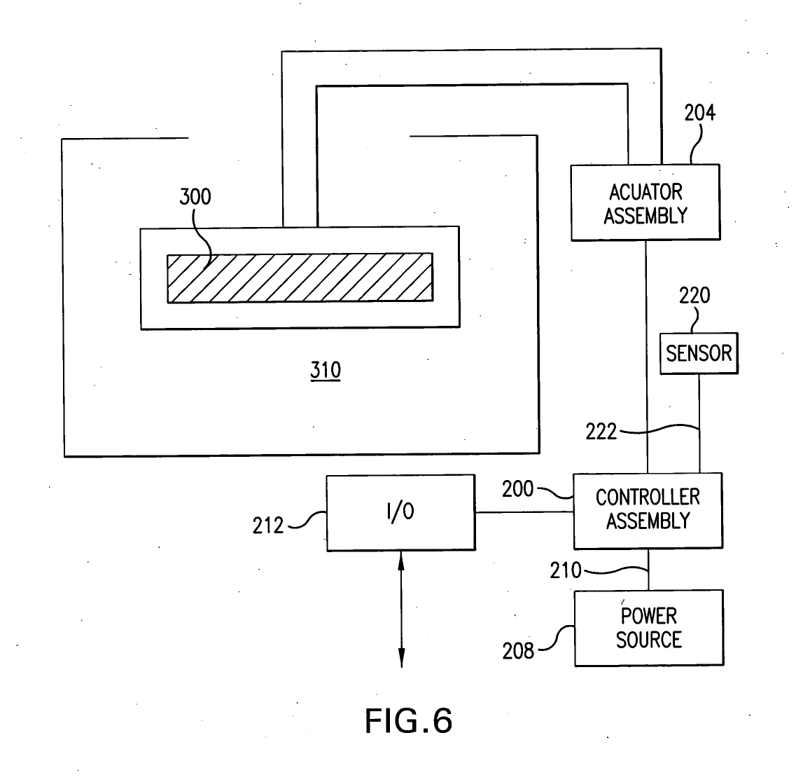

Particularly, the assembly 10 includes a carrier portion 12 and a top portion 14 which is adapted to be selectively moved from a first position (shown in FIG. 1) remote from the carrier portion 12, to a second position, shown best in FIG. 6, in which the top portion 14 abuts and engages the carrier portion 12. In one non-limiting embodiment of the invention, the portions 12 and 14 are substantially identical and the following description of the carrier portion 12 is equally applicable to the top portion 14 and these portions 12, 14 selectively abut along the respective perimeter flanges 15. Further, in the most preferred embodiment of the invention, the carrier portion 12 may be fixedly resident within a fixture, such as fixture 16 which supports the perimeter flange 15 of the carrier portion 12 and thus raises the portion 12 off of the ground 17. However, it should be realized that nothing in this description is meant to, nor should, limit the present invention to use with a particular type of fixture, such as fixture 16 and it should be realized that the carrier portion 12 may be operatively resident within any sort of desired fixture assembly or even reside upon the ground 17.

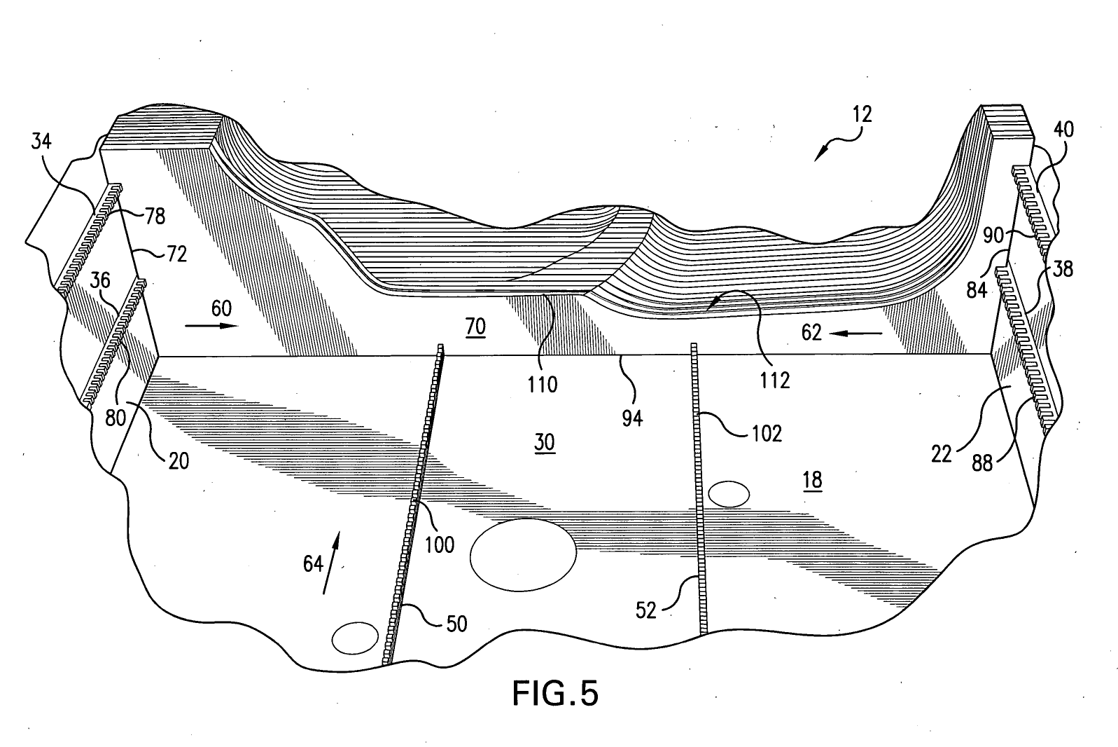

Particularly, as shown perhaps best in FIG. 5, the carrier portion 12 includes a floor portion 18 and a first pair of generally flat and opposed walls 20, 22 which are coupled to and/or integrally formed with the floor portion 18. Further, the carrier portion 12, as shown best perhaps in FIG. 1, includes a second pair of opposed and generally flat walls 24, 26 which are similarly coupled to and/or integrally formed with the floor portion 18. Thus, the walls 20, 22, 24, 26 cooperate with the floor portion 18 to form a containment cavity 30 and in the most preferred embodiment of the invention, the walls 20, 22, 24, and 26 are substantially identical and respectively extend from the floor portion 18 at respective right angles.

Further, first and second substantially identical teeth strips 34, 36 are operatively disposed along the entire length of wall 20 and are in parallel relation to each other. Third and fourth substantially identical teeth strips 38, 40 are operatively disposed upon the entire length of the wall 22 and are in parallel relation to each other. The strips 38, 40, in the most preferred embodiment of the invention, are substantially identical to teeth strips 34, 36. In the most preferred embodiment of the invention, teeth strips 34, 40 are in a coplanar relationship to each other and the plane which contains the teeth strips 34, 40 is parallel to the floor 18. Similarly, the teeth strips 36, 38 are in a coplanar relationship to each other and the plane which contains the teeth strips 36, 38 is parallel to the floor 18 and is parallel to the plane containing the teeth strips 34, 40. That is, the height of tooth strip 36 from the floor portion 18 is substantially similar to the height of tooth strip 38 from the floor portion 18, while the height of the tooth strip 34 from the floor portion 18 is substantially similar to the height of the tooth strip 40 from the floor portion 18.

Further, as best shown in FIG. 5, the carrier assembly or portion 12 includes two substantially identical teeth strips 50, 52 which are each linearly coextensive and parallel to each of the teeth strips 34, 36, 38, and 40. Particularly, each of strips 34, 36 have teeth which protrude into the containment cavity 30 in a first direction 60 and each of the strips 38, 40 have teeth which protrude into the containment cavity 30 in a second direction 62 which is opposite to the first direction 60. The strips 50, 52 have teeth which protrude in a direction 64 away from the floor 18. In the most preferred embodiment of the invention, the distance between wall 20 and the tooth strip 50 is substantially similar to the distance between the wall 22 and the tooth strip 52. As will be seen below, these tooth strips 34, 36, 38, 40, 50, and 52 cooperatively allow plates to be selectively, removably, and fixedly placed within the containment cavity 30 in a manner which allows pre-formed part or item to be cooled and which allows an item to be formed and then efficiently cooled. It should be realized that the term “pre formed” part or item, as used in this description, is meant to and does refer to an item which has been created by the use of substantially any desired item or part creation process (e.g., such as, but not limited to by use of a conventional tooling assembly such as that which is used to create an automobile fuel tank) and which must thereafter be cooled in order to create the item or part production process or strategy. These teeth strips 34, 36, 38, 40, 50, 52 and more particularly the teeth which are formed upon these teeth strips 34, 36, 38, 40, 50, and 52 allow the selectively contained plates to be accurately and easily positioned in a desired manner necessary for the contained plates to cooperatively perform a cooling or forming/cooling operation. Further, these teeth cooperatively allow the contained plates to be easily removed and replaced for maintenance and servicing type operations to easily accomplished and further allows different plates (e.g., those having a desired spatial geometry) to replace currently deployed plates in order to allow a different item or pre-formed part or item to be selectively cooled and/or formed. These plates will now be more fully discussed below. However it should be realized that different types and amounts of teeth strips, other than those which are shown and described with respect to the carrier portion 14 may be deployed within the carrier portion 14 and the top portion 12 and that nothing in this description is meant to or does limit the present invention to a particular number of teeth, to a particular number of teeth strips, or to a particular deployment of teeth or teeth strips within the carrier portion 14 or within the top portion 12.

Thus, in the most preferred although non-limiting embodiment of the invention, the assembly 10 includes a first portion of plates 70. Each of the first portion of plates 70 have a respective first edge portion 72 which is selectively and frictionally and removably/fixedly received by and between unique pairs of adjacent teeth 78 on strip 34 and by and between unique pairs of adjacent teeth 80 on the strip 36. Further, each of the plates 70 include a second opposed outer edge 84 which is selectively and frictionally and removably/fixedly received by and between unique pairs of adjacent teeth 88 on the strip 38 and by and between unique pairs of adjacent teeth 90 on the strip 40. Moreover, each of the plates 70 include a third edge 94 which is selectively and frictionally and removably/fixedly received by and between unique pairs of adjacent teeth 100 on the strip 50 and by and between unique pairs of adjacent teeth 102 on the strip 52.

In this manner, the plates 70 may be selectively and removably placed within the containment cavity 30 and each of the plates 70 have an outer surface or edge 110 (e.g. the surfaces or edges which respectively abut or receive a pre-formed part or item) which has a certain spatial geometry which allows the various outer surfaces 110 to cooperatively form or obtain a certain spatial shape, such as that which is shown in FIG. 2, which is a mirror image of one half of a pre-formed object to be received, such as a pre-formed automotive fuel tank. Thus, it should be appreciated that the various edges or surfaces 110 may be respectively formed upon the various plates 70 and after these plates 70 are fixed within the containment cavity 30, the respective surfaces 110 form the desired spatial geometry which is a mirror image of one half of the pre-formed item to be cooled and/or formed/cooled.

It should be noted that in this non-limiting embodiment of the invention, a pair of adjacent plates 70 are separated by a distance equal to the width of the tooth which separates them. Thus, each plate 70 is therefore separated from its adjacent or “neighbor” plates by a certain space or gap 112 which is equal to the respective width of the respective teeth which separate the respective plates 70 from their respective neighbor or adjacent plates 70. In the most preferred embodiment of the invention, this gap 112 is substantially uniform or similar and occurs between each pair of plates 70 which are selectively and fixedly received within the containment cavity 30. In one non-limiting embodiment of the invention, the assembly 10 only includes such plates as plates 70.

However, in an alternate (although non-limiting) embodiment of the invention, a second group of plates, such as plates 130, are used in order to allow for a smooth geometric “mirror image” contour or surface geometry to be realized within the containment cavity 30.

Particularly, as shown best perhaps in FIGS. 1 and 5, these second portion of plates 130 are received in only some of the teeth strips, such as teeth strips 34, 36, and 50 and orthogonally abut (at a substantial right angle) with some of the first portion of plates 70. The placement of this second portion of plates 130 within the containment cavity 30 is determined by the nature of the desired spatial geometry needed to be formed by the various edges or surfaces 110.

As shown best in FIG. 1, in the most preferred embodiment of the invention, the assembly 10 further includes a controller assembly 200 which is operable under stored program control and which includes a processor and a memory. The assembly 10 also includes an actuator assembly 204 which is coupled to the controller assembly 200. In one non-limiting embodiment of the invention, the actuator assembly comprises a hydraulic cylinder assembly, a solenoid assembly, or substantially any other desired assembly which is adapted to selectively and reciprocally move an object under some centralized control strategy.

The assembly 10, in the most preferred embodiment of the invention, further includes a source of electrical power 208, such as an electrical battery, which is physically and communicatively coupled to the controller assembly 200 by use of the bus 210 and which provides operating power to the controller assembly 200. The assembly 10, in the most preferred embodiment of the invention, further includes an input/output portion 212 which is physically and communicatively coupled to the controller assembly 200 by use of the bus 214, and a position sensor assembly 220 which is physically and communicatively coupled to the controller assembly 200 by use of the bus 222.

The actuator assembly 204 is coupled to the top portion 14 and, in one non-limiting embodiment of the invention, the top portion 14 includes a surface 225 which is formed by a plurality of plates, such as plates 70 and which cooperates with the surface 110 to form a mirror image of the entire outer surface of the item to be cooled, such as an automotive fuel tank (e.g., each of the surfaces 110 and 225 are substantially identical and respectively form a mirror image of a unique one half to the item or pre-formed part to be cooled or formed/cooled). It should be realized that the controller assembly 200 acts in accordance with its stored program which it may receive through the input/output portion 212 and with a sensed position of the top portion 14 and/or the actuator assembly 204 which it receives from the sensor 220.

Thus, in operation, the item to be cooled (e.g., the preformed fuel tank 300) is placed within the containment cavity 30 and the top member 14 is made to be selectively moved, by the controlled operation of the actuator assembly 204, into an abutting engagement with the contained item 300. In this manner, the surfaces 110 and 225 cooperatively and fixedly receive one-half of the contained item 300. Water or some other cooling medium may then be made to surround the members 14, 12 (e.g., the members 12, 14 may be selectively immersed into a source of water or cooling medium 310 by placement of the members 14, 12 into the cooling medium by a conventional transport assembly or manually). The cooling water or medium 310 rapidly contacts the contained item 300 due to the plurality of equidistantly spaced gaps 112 and the large pre-formed part or item contacting surface area 110 and 225 further cooperatively draw heat away from the contained item 300. In this manner, the contained item 300 is rapidly cooled. After a very short period of time, the portions 12 and 14 are removed from the medium 310 and the cooled item 300 is removed.

In another non-limiting embodiment of the invention, the gaps are filled with some adhesive material and the members 12, 14 may actually form and cool the item 300. It should be realized that the cooling medium may comprise air or some other non-water medium which is applied to the members 12, 14 and the cooling is achieved by use of the large surface area which actually contacts the formed item or product.

It is to be understood that the present invention is not limited to the exact construction and methodology which has been illustrated and described above, but that various changes and modifications may be made without departing from the spirit and the scope of the inventions as are more fully delineated in the following claims.

What is claimed is:

1) An assembly comprising a plurality of spaced apart plates which are fixed within a carrier and which cooperatively define the shape of a certain item.

2) The assembly of claim 1 wherein said certain item comprises an automotive fuel tank.

3) The assembly of claim 1 wherein said assembly further includes a quantity of sealing material which is disposed between at least some of said plurality of plates.

4) An assembly comprising a first carrier portion having a floor which includes a first strip of protruding teeth, a first wall which includes a second strip of protruding teeth, and a second wall which includes a third strip of protruding teeth and wherein said first and second walls cooperate with said floor to form a containment portion and wherein said second and third strips of protruding teeth extend in opposite directions and into said containment portion and are linearly coextensive, and a plurality of plates which are fixedly secured within said containment area, wherein each of said plurality of plates is respectively disposed between two unique teeth of said first strip of protruding teeth, between two unique teeth of said second strip of protruding teeth, and between two unique teeth of said third strip of protruding teeth; and a second top portion which is adapted to selectively engage said carrier portion.

5) The assembly of claim 4 wherein a first portion of said plates are orthogonally positioned relative to a second portion of said plates.

6) The assembly of claim 5 further comprising sealer material which is disposed between pairs of adjacent plates.

7) The assembly of claim 4 further comprising a controller assembly which is coupled to said top portion and which causes said top portion to selectively engage said carrier portion.

8) An assembly for forming and cooling a part comprising a substantially rectangular carrier having a floor and two pairs of opposed walls which cooperate with said floor to form a containment cavity, wherein said assembly includes a first strip of teeth which is disposed above said floor and along the entire length of a first of said walls; a second strip of teeth which is disposed along the entire length of a second of said walls and wherein said second strip of teeth is linearly coextensive to said first strip of teeth; and a third strip of teeth which is disposed upon said floor and which is linearly coextensive to said first and second strips of teeth and wherein said first strip of teeth extend into said containment cavity in a first direction and wherein said second strip of teeth extend into said containment cavity in a second direction which is opposite to said first direction; and wherein said assembly further includes a first plurality of plates which are respectively disposed between unique pairs of teeth on said first strip of teeth and between unique pairs of teeth on said second strip of teeth, and between unique pairs of teeth on said third strip of teeth.

9) The assembly of claim 8 wherein said assembly further comprises a quantity of sealing material which is disposed between adjacent pairs of said plates.

10) The assembly of claim 8 wherein said assembly further includes a fourth strip of teeth which are disposed upon a third of said walls and a fifth strip of teeth which are disposed upon a fourth of said walls and wherein said assembly includes a second plurality of plates which are respectively fixed within said containment portion between unique pairs teeth of said fourth strip of teeth and which orthogonally abut at least one of said first plurality of plates.

11) The assembly of claim 10 further comprising a third plurality of plates which are respectively fixed within said containment portion and between unique pairs of teeth of said fifth strip of teeth and which orthogonally abut at least a second one of said first plurality of plates.

12) The assembly of claim 8 further comprising a top portion which is adapted to selectively engage said carrier portion.

14) A method of cooling an item comprising the steps of creating an assembly containing spaced apart plates; and placing said item upon said spaced apart plates; and placing a cooling media in contact with said assembly.

15) The method of claim 14 wherein said step of placing a cooling media in contact with said assembly comprises the step of immersing said assembly in water.

16) The method of claim 14 wherein said step of placing a cooling media in contact with said assembly comprises the step of causing air to be transmitted through the openings formed between said spaced apart plates.

17) The method of claim 14 wherein said item comprises a fuel tank.

18) A method of forming and cooling an item comprising the step of forming an assembly which includes a carrierhaving a plurality of spaced apart plates; forming said item within said carrier by use of said plurality of spaced apart plates; and cooling said formed item.

19) The method of claim 18 wherein said step of cooling said item comprises the step of immersing said carrier within water.

20) The method of claim 18 wherein said step of cooling said item comprises the step of placing a cooling medium in contact with said carrier.
